(19) United States
(12) Patent Application Publication
(10) Pub. No.: US 2024/0288932 A1
(43) Pub. Date: Aug. 29, 2024

(54) METHOD, APPARATUS, DEVICE AND STORAGE MEDIUM FOR INTERACTING IN A VIRTUAL ENVIRONMENT

(71) Applicant: Beijing Zitiao Network Technology Co., Ltd., Beijing (CN)

(72) Inventors: Xindu MA, Beijing (CN); Xi Li, Beijing (CN)

(21) Appl. No.: 18/584,843

(22) Filed: Feb. 22, 2024

(30) Foreign Application Priority Data
Feb. 23, 2023 (CN) 202310193047.3

(51) Int. Cl. G06F 3/01; G06T 7/70; G06T 19/00

(52) U.S. Cl. CPC G06F 3/011; G06T 7/70; G06T 19/006; G06T 2207/30196

(57) ABSTRACT

According to embodiments of the present disclosure, a method, an apparatus, a device, and a storage medium for interacting in a virtual environment are provided. The method includes obtaining an image of a physical scene, the physical scene containing a physical interaction device; determining, based on the obtained image, a relative position of a predetermined object with respect to the physical interaction device; and displaying, in a virtual scene corresponding to the physical scene, a virtual interaction device corresponding to the physical interaction device and an indication of the relative position. In this way, the embodiments of the present disclosure can make it easier and more accurate for users to operate a device in the virtual environment, thereby improving user experience.

### CROSS-REFERENCE TO RELATED APPLICATION

The present application claims priority to Chinese Patent Application No. 202310193047.3, filed on Feb. 23, 2023 and entitled “METHOD, APPARATUS, DEVICE AND STORAGE MEDIUM FOR INTERACTING IN A VIRTUAL ENVIRONMENT”, the entirety of which is incorporated herein by reference.

### FIELD

Example embodiments of the present disclosure generally relate to the field of computers, and in particularly, to a method, an apparatus, a device and a computer readable storage medium for interacting in a virtual environment.

### BACKGROUND

In recent years, Extended Reality (referred to as XR) has been widely studied and applied. XR integrates virtual content and a real scene through a combination of a hardware device and various technical means, providing users with a unique sensory experience. XR, for example, includes Virtual Reality (VR), Augmented Reality (AR), Mixed Reality (MR), or the like. VR simulates a virtual world in three-dimensional space using a computer, providing users with an immersive experience in terms of vision, hearing, touch, or the like. AR allows a real environment and a virtual object to be superimposed in the same space in real time and exist simultaneously. MR is a new visual environment that integrates the real world and the virtual world, where an object in a physical real-world scene coexists in real time with an object in the virtual world.

### SUMMARY

In a first aspect of the present disclosure, there is provided a method for interacting in a virtual environment. The method includes: obtaining an image of a physical scene, the physical scene containing a physical interaction device; determining, based on the obtained image, a relative position of a predetermined object with respect to the physical interaction device; and displaying, in a virtual scene corresponding to the physical scene, a virtual interaction device corresponding to the physical interaction device and an indication of the relative position.

In a second aspect of the present disclosure, there is provided an apparatus for interacting in a virtual environment. The apparatus includes an obtaining module configured to obtain an image of a physical scene, the physical scene containing a physical interaction device; a position determining module configured to determine, based on the obtained image, a relative position of a predetermined object with respect to the physical interaction device; and a displaying module configured to display, in a virtual scene corresponding to the physical scene, a virtual interaction device corresponding to the physical interaction device and an indication of the relative position.

In a third aspect of the present disclosure, there is provided an electronic device. The device comprises at least one processing unit; and at least one memory, the at least one memory being coupled to the at least one processing unit and storing an instruction for execution by the at least one processing unit. The instruction, when executed by the at least one processing unit, causes the device to perform the method of the first aspect.

In a fourth aspect of the present disclosure, there is provided a computer-readable storage medium. The computer readable storage medium, having stored thereon a computer program which, when executed by a processor, implements the method of the first aspect.

It should be understood that the contents described in the content section of the present invention are not intended to limit the key features or important features of the embodiments of the present disclosure, nor are they intended to limit the scope of the present disclosure. Other features of the present disclosure will become readily understood from the following description.

### BRIEF DESCRIPTION OF THE DRAWINGS

The above and other features, advantages and aspects of the various embodiments of the present disclosure will become more apparent in combination with the accompanying drawings and with reference to the following detailed description. In the drawings, like or similar reference numerals denote like or similar elements.

FIG. 1 shows a block diagram of an environment according to some embodiments of the present disclosure;

FIG. 2 shows a flowchart of an example process for interacting in a virtual environment according to some embodiments of the present disclosure;

FIG. 3 shows a schematic diagram of a virtual scene with respect to a keyboard according to some embodiments of the present disclosure;

FIG. 4 shows a schematic diagram of a virtual scene with respect to a keyboard according to some further embodiments of the present disclosure;

FIG. 5 shows a schematic diagram of a virtual scene with respect to a keyboard according to some other embodiments of the present disclosure;

FIG. 6A shows a schematic diagram of a virtual scene with respect to a keystroke operation according to some embodiments of the present disclosure;

FIG. 6B shows a schematic diagram of a virtual scene with respect to a keystroke operation according to some embodiments of the present disclosure;

FIG. 6C shows a schematic diagram of a virtual scene with respect to a keystroke operation according to some embodiments of the present disclosure;

FIG. 7 shows a schematic diagram of a virtual scene with respect to a manipulator according to some embodiments of the present disclosure;

FIG. 8 shows a schematic diagram of a virtual scene with respect to the manipulator according to further embodiments of the present disclosure;

FIG. 9 shows a schematic diagram of a virtual scene with respect to the manipulator according to some other embodiments of the present disclosure;

FIG. 10 shows a schematic diagram of a virtual scene with respect to the manipulator according to some embodiments of the present disclosure;

FIG. 11A shows a schematic diagram of a menu associated with a physical interaction device according to some embodiments of the present disclosure;

FIG. 11B shows a schematic diagram of a virtual menu associated with a virtual interaction device according to some embodiments of the present disclosure;

FIG. 12 shows a schematic diagram of a virtual interaction device according to some embodiments of the present disclosure;

FIG. 13 shows a schematic diagram of a virtual interaction device according to some further embodiments of the present disclosure;

FIG. 14 shows a schematic diagram of a virtual interaction device according to some other embodiments of the present disclosure;

FIG. 15 shows a block diagram of an apparatus for interacting in a virtual environment according to some embodiments of the present disclosure; and

FIG. 16 shows a block diagram of a device capable of implementing multiple embodiments of the present disclosure.

### DETAILED DESCRIPTION

The following will describe embodiments of the present disclosure in more detail with reference to the accompanying drawings. Although certain embodiments of the present disclosure are shown in the drawings, it should be understood that the present disclosure can be implemented in various forms and should not be construed as limited to the embodiments set forth herein. On the contrary, these embodiments are provided for a more thorough and complete understanding of the present disclosure. It should be understood that the accompanying drawings and embodiments of the present disclosure are for illustrative purposes only and are not intended to limit the scope of protection of the present disclosure.

In the description of embodiments of the present disclosure, the term “including” and similar terms should be understood as open-ended inclusion, that is, “including but not limited to”. The term “based on” should be understood as “at least partially based on”. The term “one embodiment” or “the embodiment” should be understood as “at least one embodiment”. The term “some embodiments” should be understood as “at least some embodiments”. The following may also include other explicit and implicit definitions.

In the description of embodiments of the present disclosure, the term “XR” includes but is not limited to “VR”, “AR”, and “MR”. It should be understood that the term “XR” can be any of “VR”, “AR”, and “MR”, or any combination thereof. In the following description, only for the convenience of description, “XR” is used in the embodiments of the present disclosure to represent one or more of “VR”, “AR”, and “MR”, or any combination thereof.

The term “in response to” indicates that a corresponding event occurs or a condition is satisfied. It would be understood that the timing of subsequent actions executed in response to the event or the condition is not necessarily strongly related to the time when the event occurs or the condition is satisfied. In some cases, subsequent actions can be executed immediately when the event occurs or the condition is satisfied; in other cases, subsequent actions can also be performed after a period of time after the event occurs or the condition is satisfied.

It should be understood that data involved in this technical solution (including but not limited to the data itself, acquisition or use of the data) should comply with the requirements of corresponding laws, regulations and relevant provisions.

It should be understood that, prior to the use of the technical solutions disclosed in respective embodiments of the present disclosure, appropriate manners should be taken to inform the user of the type of personal information involved, the scope of use, use scenarios and the like, and obtain authorization from the user in accordance with relevant laws and regulations.

In existing displays and interactions of XR, a virtual object is usually rendered and then simply superimposed on an actual view. In some scenarios, a real object may also be virtualized in the XR environment. However, a projection of the real object (for example, a physical interaction device such as a keyboard, a mouse, and a controller) may sometimes have a physical error that may cause a related interactive operation to be performed incorrectly. In addition, a user needs to press a corresponding key, and then rely on feedback to determine if the key has been pressed correctly, which incurs a certain cost of trial-and-error, reducing user experience.

Regarding the above and other potential problems, the embodiments of the present disclosure provide a solution for interacting in a virtual environment. In this solution, a virtual interaction device corresponding to the physical interaction device and an indication of a relative position are displayed in a virtual scene corresponding to a physical scene, by detecting the relative position of a predetermined object with respect to the physical interaction device. For example, when the predetermined object (for example, a user) interacts with the physical interaction device, the solution can increase real-time feedback to a virtual object model by detecting a user behavior and can increase an interactive area near the physical interaction device, which can be triggered by a user behavior.

Before describing various example embodiments of the present disclosure with reference to the accompanying drawings, several terms used in the present disclosure will be defined firstly.

The term “object” used herein refers to one or more parts of a user who interacts with the physical interaction device in a real environment (that is, the physical scene), such as a finger. The user is an operator or a user of the physical interaction device, for example but not limited to an inputter who taps a keyboard, an operator who clicks a mouse to make a selection, a gamer who manipulates a manipulator, and so on.

The term “physical interaction device” used herein refers to a device used by an object in the real environment (that is, the physical scene) for interaction. Such a physical interaction device can also be used to control a physical input/output (I/O) device in the virtual scene, an example of which may include, but is not limited to, a device such as a keyboard, a mouse, a manipulator, or the like.

The term “virtual interaction device” used herein refers to a corresponding device of the physical interaction device in the virtual environment, and an operation of the object on the physical interaction device can be correspondingly reflected on the virtual interaction device in the virtual world.

For example, when a user presses a key on the keyboard in a physical scenario, a corresponding key on a virtual keyboard that corresponds to the keyboard can be displayed as being pressed in the virtual environment. However, it should be understood that this is only an example, and the correspondence between the virtual interaction device and the physical interaction device may be achieved through various specific means.

The example embodiments of the present disclosure will be described below with reference to the accompanying drawings.

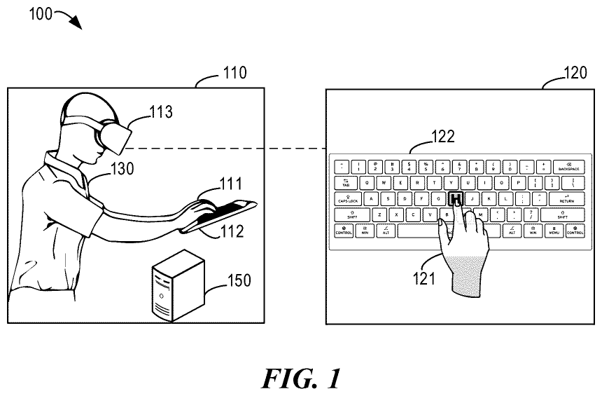

FIG. 1 shows a block diagram of an environment 100 according to some embodiments of the present disclosure. As shown in the figure, a physical scene 110 is shown in the environment 100. The physical scene 110 is an example of a real-world scenario, where a user 130 is using an object (such as a finger) 111 to tap a key on a physical interaction device (such as a keyboard) 112. Assuming that the user 130 is wearing an XR device 113, such as a head mounted display, smart glasses, or the like, the XR device 114 may display a virtual environment 120 that corresponds to the physical scene 110 to the user 130.

In the physical scene 110, there is also an electronic device 150 for obtaining an image of the physical scene 110 and determining the relative position between the object (such as a finger of the user 130) 111 and the physical interaction device (such as the keyboard) 112 based on the image. For example, a first spatial coordinate of the finger 111 and a second spatial coordinate of the keyboard 112 may be determined, and a relative positional relationship between the object 111 and the physical interaction device 112 in space may be determined based on these two spatial coordinates. As another example, the distance between the object 111 and the physical interaction device 112 may be directly determined based on the first spatial coordinate and the second spatial position coordinate, so that it can be further determined whether they are in contact (the distance is 0) or there is a gap (the distance is greater than 0), and the size of the distance, and so on.

The electronic device 150 may be a separate device capable of communicating with the XR device 113 and/or other image capture devices, such as a server for image or data processing, a computing node, or the like, or may be integrated with the XR device 113 and/or other image capture devices. In some embodiments, the electronic device 150 may be implemented as the XR device 113, that is, in this case, the XR device 113 may implement all the functions of the electronic device 150. It should be understood that the foregoing description of the electronic device 150 is merely an example and not limiting. The electronic device 150 may be implemented as a variety of forms, structures, or types of devices, and the embodiments of the present disclosure herein are not limiting.

Based on the image of the physical scene 110, the electronic device 150 may determine whether the finger 111 is in direct contact with the keyboard 112 or has a certain distance with the keyboard 112. If there is a certain distance, the electronic device 150 may determine the size of the distance. For example, if the finger 111 contacts one or more keys on the keyboard 112, or a distance between the finger 111 and the one or more keys is less than a predetermined distance, then the electronic device 150 may determine which key or keys on the keyboard are the one or more keys, or which key or keys are involved with the one or more keys.

The electronic device 150 may cause a virtual keyboard 122 that corresponds to the keyboard 112 to be displayed in the virtual environment 120 and may cause an indication of the relative position to be displayed in the virtual environment 120. For example, the electronic device 150 may make a virtual key corresponding to the one or more keys on the virtual keyboard 122 to be highlighted. In some embodiments, the virtual key may be graphically represented, and processes such as highlighting, color-deepening, color-changing, or the like may be performed on a graphical representation, thereby achieving a prominent display of the virtual key.

Therefore, the user 130 may see the virtual keyboard 122 that corresponds to the keyboard 112 the user 130 is using in the virtual environment 120, as well as a situation where the user 130 uses the keyboard 112.

Further, in some embodiments, the finger 111 of the user 130 in the virtual environment 120 may be displayed as a virtual finger 121. In this way, the user 130 may more intuitively see that the virtual finger 121 can operate the virtual keyboard 122 in the same way as the real finger 111 of the user operates the keyboard 112.

In this manner, the user 130 can conveniently and accurately use the keyboard 112 to enter characters in the virtual environment 120, reducing the uncertainty of the operation and enhancing the user experience.

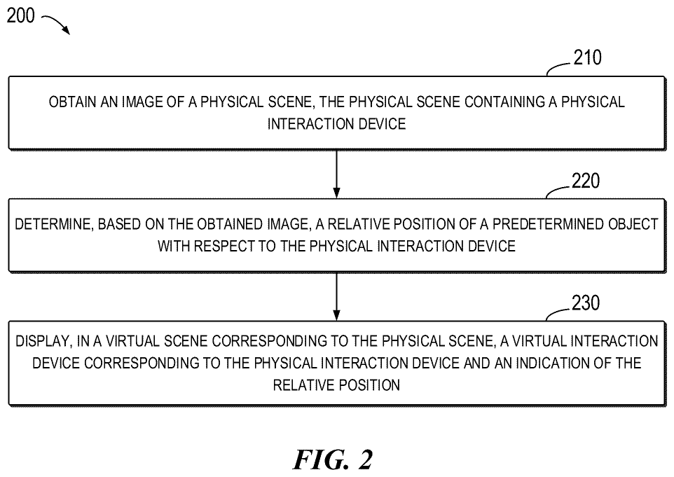

FIG. 2 shows a flowchart of a method 200 for interacting in a virtual environment according to some embodiments of the present disclosure. The method 200 may be performed by the electronic device 150 of FIG. 1. For convenience of discussion, the electronic device 150 will be described later as an example. However, this is merely an example and does not limit the embodiments of the present disclosure in any way. It should be understood that the embodiments of the present disclosure may also be performed by other suitable servers or computing devices.

At block 210, the electronic device 150 obtains an image of a physical scene and the physical scene contains a physical interaction device. The physical scene is a scene in the real world, and the physical scene includes real people or things, such as the physical scene 110 in FIG. 1. The physical interaction device is a physical device, such as a keyboard, a mouse, a manipulator, or the like, that can be used by users to perform an input operation and/or an output operation.

The following description is based on the embodiment shown in FIG. 1. As shown in FIG. 1, the physical scene 110 contains the user 130 and the physical interaction device 112 that the user 130 is operating. Such a physical interaction device 112 may include, for example, a physical I/O device associated with the virtual scene, such as the keyboard 112.

According to the embodiments of the present disclosure, the electronic device 150 may obtain an image of the physical scene 110 in various ways. For example, the image of the physical scene 110 may be captured by the XR device 114 worn by the object 130, and the electronic device 150 may obtain the image of the physical scene 110 from the XR device 114 accordingly. As an alternative, the image of the physical scene 110 may also be captured by an image capture device (such as a webcam, a camera, or the like) communicatively connected to the electronic device 150 and sent to the electronic device 150. In other alternative implementations, the electronic device 150 itself may have an image capture function, such as an installed webcam or camera, or the like. In this case, the electronic device 150 may capture the image of the physical scene 110 containing the physical interaction device 112 at block 210.

At block 220, the electronic device 150 determines, based on the obtained image, a relative position of a predetermined object with respect to the physical interaction device. The predetermined object is a device, an object, or a part through which a user can operate the physical interaction device.

For example, the predetermined object may be the finger 111 of the user 130, a stylus used by the user 130, and so on.

The relative position of the predetermined object with respect to the physical interaction device may be determined in various ways. As shown in FIG. 1, the electronic device 150 may determine a position of the finger 111 of the user 130 relative to the keyboard 112 at block 220. Specifically, the electronic device 150 may determine which position of the finger 111 is relative to the keyboard 112, such as hovering above the keyboard or on the side of the keyboard. The electronic device 150 may also determine which key or keys on the keyboard 112 the finger 111 is directly above, a distance between the finger 111 and the keyboard 112, and so on. In some embodiments, the relative position of the finger 111 of the user 130 relative to the physical keyboard 112 may be determined by See-Through technology or the like.

At block 230, the electronic device 150 displays, in a virtual scene corresponding to the physical scene, a virtual interaction device corresponding to the physical interaction device and an indication of the relative position.

The electronic device 150 may determine how to display an operation of the object 111 on the keyboard 112 in the virtual environment 120 based on a comparison between a distance between the object and the physical interaction device and a predetermined distance. In some embodiments, the electronic device 150 may determine a corresponding physical area of the physical interaction device in response to the distance between the object and the physical interaction device being less than the predetermined distance. Such a corresponding physical area may be associated with the object.

Furthermore, the electronic device 150 may display the indicator with respect to the relative position, in association with the virtual area on the virtual interaction device corresponding to the physical area.

In the embodiments of FIG. 1, if the electronic device determines that the distance between the finger 111 and the keyboard 112 is greater than or equal to the predetermined distance, the electronic device 150 may consider that the user 130 did not operate the keyboard 112, and therefore there is no need to reflect the operation of the user on the physical interaction device in the virtual environment 120.

On the contrary, if the distance is less than or equal to the predetermined distance, it may be considered that the finger 111 of the user 130 is close enough to the keyboard 112. Specifically, if the distance is 0, it may be considered that the finger 111 is in direct contact with the keyboard 112. In these cases, the electronic device 150 may determine the physical area of the physical interaction device 112 to which the object 111 is directed, such as a position and a range of one or more keys that the finger 111 is tapping, and the indication of the relative position is displayed in association with the virtual area corresponding to the physical area (for example, the virtual key related to the position and the range) on the virtual keyboard. For example, the virtual area may be highlighted, or displayed in a form of a heat map, and so on.

In some embodiments, the electronic device 150 may determine whether a target interaction element on the physical interaction device, to which the object is directed, can be determined based on the relative position determined at block 220. If the target interaction element can be determined, the electronic device 150 may cause one or more virtual interaction elements on the virtual interaction device 122 corresponding to the target interaction element to be highlighted.

In the embodiments of the present disclosure, the target interaction element is part of the physical interaction device. For example, if the physical interaction device is a keyboard, the interaction element may be a key on the keyboard, and the target interaction element may be the key that the user is tapping. As another example, if the physical interaction device is a mouse, the interaction element may be a left key, a right key, or another possible key of the mouse, and the target interaction element may be the key that the user is clicking. As another example, if the physical interaction device is a manipulator, the interaction element may be a key on the manipulator, and the target interaction element may be the key that the user is pressing on.

Similarly, the virtual interaction element is a part of the virtual interaction device, and the virtual interaction element corresponds to the target interaction element of the physical interaction device. For example, if the target interaction element is a key on the keyboard that the user is tapping, the virtual interaction element is a corresponding key on the virtual keyboard; if the target interaction element is the left key on the mouse that the user is clicking, the virtual interaction element is a corresponding left key on a virtual mouse; and if the target interaction element is a key on a manipulator that the user is pressing, the virtual interaction element is the corresponding key on a virtual manipulator.

In some embodiments, there are various ways to decide whether the target interaction element can be determined. For example, the relative position of a finger of the user with respect to the physical keyboard may be located through the See-Through technology. Then, whether a fingertip of a single finger of the user 130 completely covers a single key may be determined based on the relative position. If so, it can be determined that the key is the target interaction element.

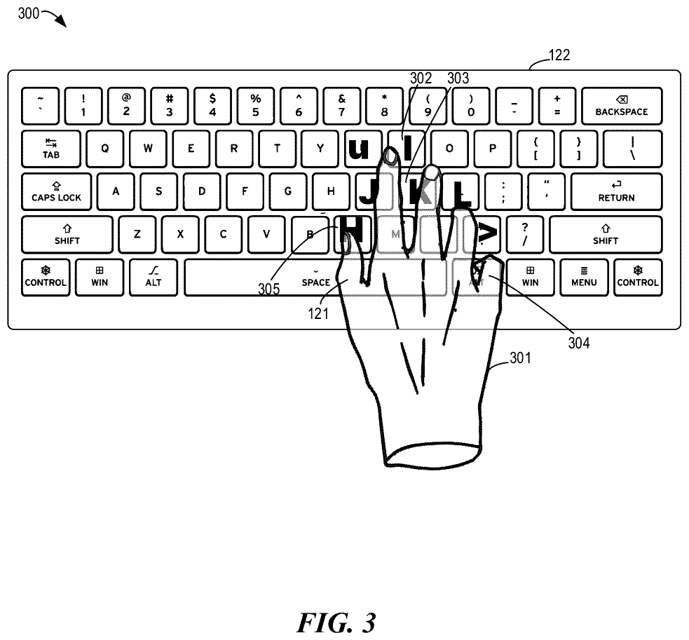

FIG. 3 shows a schematic diagram of a virtual scene 300 with respect to a keyboard in which the target interaction element can be determined, in accordance with some embodiments of the present disclosure. In the embodiment shown in FIG. 3, a virtual model of the keyboard 112, that is, the virtual keyboard 122, may be displayed in the virtual scene 120 after the user 130 accesses the physical keyboard (sometimes directly referred to herein as a “keyboard”) 112.

In some embodiments, at least a portion of the virtual object representing an object may be displayed in the virtual scene with a predetermined transparency. The virtual object may be a virtual model of an object in the physical scene, such as the virtual finger 121. As shown in FIG. 3, the finger 121 of a virtual avatar (not shown) of the user 130 may be displayed in a gradient translucent material. At the same time, a hand outline 301 of the virtual avatar may be unaffected by the gradient translucency.

In the physical scenario corresponding to the embodiment shown in FIG. 3, the user 130 places the finger 111 accurately on the keyboard 112, and each finger corresponds to a specific key, such as “I”, “O”, “P”, “n”. That is, the virtual keyboard 122 has “focused” keys. Correspondingly, in the virtual scenario shown in FIG. 3, the corresponding virtual interaction elements (such as virtual keys) 302, 303, 304, and 305 of the virtual interaction device (such as the virtual keyboard) 122 give clear indication state prompts, such as by highlighting all or part of the virtual interaction elements. In some embodiments, different colors, increased brightness, reduced transparency, and so on may be applied to the graphical representation of the virtual interaction element to achieve the highlight of the virtual interaction element.

In some embodiments, a symbol corresponding to a virtual interaction element may be highlighted. This may be performed, for example, by displaying the content of the key in a differentiated manner. Specifically, the symbol corresponding to the virtual interaction element may be displayed in a way such as magnified displaying, transformed displaying, and using an artistic font, and so on. As shown in FIG. 3, on the virtual keyboard 122, symbols corresponding to virtual interaction elements, namely the virtual keys 302, 303, 304, and 305, are “I”, “O”, “P”, and “n”, respectively, and these symbols are displayed in a differentiated manner such as font transformation and color changing.

On the other hand, if the electronic device 150 fails to determine the target interaction element on the physical interaction device 112, to which the object is directed, based on the relative position, then one or more potential interaction elements on the physical interaction device 112 associated with the object may be determined, and an area on the virtual interaction device 122 associated with the one or more potential interaction elements is highlighted.

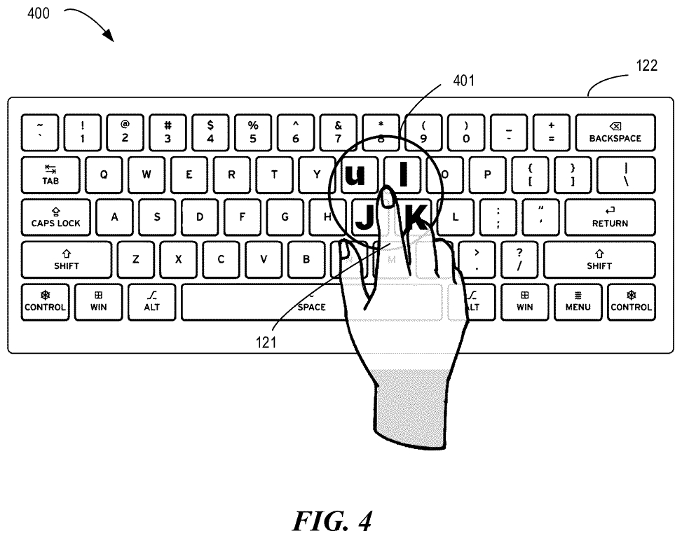

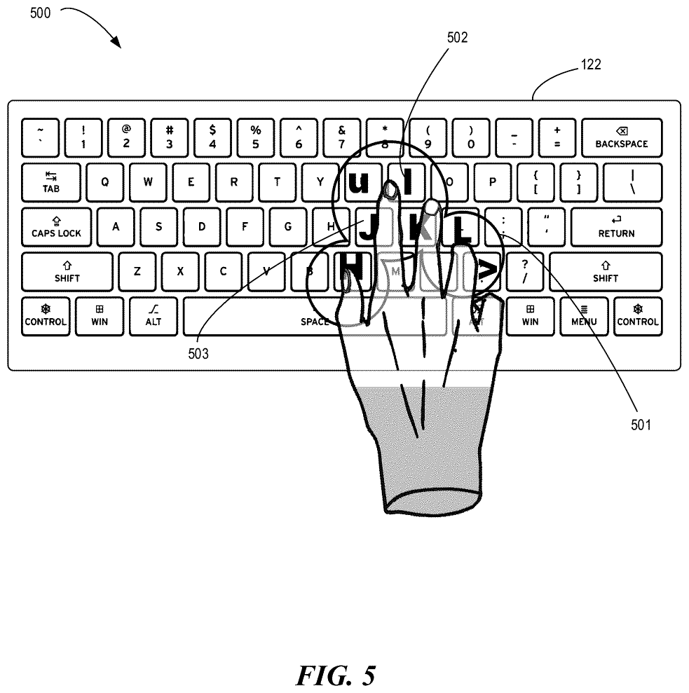

In some cases, the finger 111 of the user 130 may not touch any key on the physical interaction device 112, but may have a certain distance with any key on the physical interaction device 112. If all distances between the finger 111 and one or more keys are close enough, for example, less than the predetermined distance, then the one or more keys may be determined as potential interaction elements. At this time, the area associated with one or more potential interaction elements may be an area on the virtual interaction device that contains virtual interaction elements corresponding to the one or more potential interaction elements, or a larger area (for example, the area also contains other virtual interaction elements related to the corresponding virtual interaction elements) or a smaller area (for example, the area may not contain a virtual interaction element that are obviously unrelated to the corresponding virtual interaction elements). This is described in detail as below with regard to FIG. 4 and FIG. 5.

FIG. 4 shows a schematic diagram of a virtual scene 400 with respect to a keyboard according to some embodiments of the present disclosure, and the target interaction element fails to be determined in the virtual scene 400. Specifically, in the example of FIG. 4, the user 130 randomly places a single finger 111 on the keyboard 112, and there is no clearly focused key on the virtual keyboard 122. That is, there is no virtual interaction element corresponding to the target interaction element on the virtual interaction device. Similar to FIG. 3, in FIG. 4, the finger 121 of the virtual avatar (not shown) of the user 130 may be displayed in the gradient translucent material. At the same time, the hand outline of the virtual avatar may be unaffected by the gradient translucency.

At this time, assuming that the fingers of the object 130 are relatively close to the keys “U”, “I”, and “J” on the keyboard 112, for example, less than the predetermined distance, then the potential interaction elements on the keyboard 112 may be determined as the keys “U”, “I”, and “J”, and an area 401 associated with the keys “U”, “I”, and “J” on the virtual keyboard 122 may be highlighted.

The area 401 may be highlighted in various ways, such as displaying a graphical representation of the area 401 in a form of a heat map radiation through a form of a heat map. In this way, a key content (such as “U”, “I”, “J”, and so on) which is radiated may be highlighted. This may be performed, for example, in a differentiated manner, similar to the embodiment in FIG. 3, which will not be repeated here.

In some embodiments, the radiated key may be within a predetermined hot zone radiation range, and the hot zone radiation range may be, for example, a circle with the fingertip of the finger 121 as an origin and a radius of a predetermined size (for example, 2 cm). Additionally, in some embodiments, a gradient effect may be superimposed on the radiated key. For example, the hot zone radiation range may be radiated outward from the origin of the circle, with the transparency gradually decreasing, for example, from 100% to 5%.

FIG. 5 shows a schematic diagram of a virtual scene 500 with regard to a keyboard according to some embodiments of the present disclosure, and the target interaction element fails to be determined in the virtual scene 500. In the example of FIG. 5, the user 130 places a single finger 111 on the keyboard 112, assuming that there are focused keys and unfocused keys on the virtual keyboard 122 at this time. Similar to FIG. 3 and FIG. 4, the finger 121 of the virtual avatar (not shown) of the user 130 may be displayed in the gradient translucent material. At the same time, the hand outline of the virtual avatar may be unaffected by the gradient translucency.

As shown in FIG. 5, for focused keys (such as physical keys corresponding to virtual keys 502), the corresponding keys (such as the virtual keys 502) on the virtual keyboard 122 may be locally highlighted, and/or the contents of the keys may be displayed differentially, and there is no outward radiation.

For keys that are not clearly focused (such as physical keys corresponding to a virtual key 503), for example, if a hand of the user touches the keyboard and a fingertip is in contact with a gap between keys, then one or more potential interaction elements (such as one or more keys on the physical keyboard) on the physical interaction device may be determined, and an associated area 501 may be highlighted. For example, a graphical representation of the area 501 is displayed in a heat map manner. In a state of the heat map, for example, surrounding keys may be radiated in a form of a heat map with the center of one of the potential interaction elements. The radiated contents of the keys (such as symbols “Y”, “H”, “B” corresponding to the virtual interaction element) may be highlighted, for example, in a differentiated manner, which is similar to the embodiments of FIG. 3 and FIG. 4 and will not be repeated here.

In some embodiments, if an area associated with one or more potential interaction elements is highlighted, for the interaction elements, a highlight pattern for a virtual interaction element corresponding to the interaction element may be determined based on a distance between the interaction element and the object. A corresponding virtual interaction element may then be highlighted to the determined pattern.

Continuing to refer to FIG. 5, taking the keys corresponding to the symbols “Y” and “U” as an example, assuming that the distance between the object (finger) 111 and a first interaction element (for example, a key corresponding to the symbol “Y”) is 1 centimeter, and the distance between the object 111 and a second interaction element (for example, a key corresponding to the symbol “U”) is 0.5 centimeters, since the distance between the object and the second interaction element is smaller than the distance between the object and the first interaction element, the second interaction element may be displayed in a more detailed manner. For example, a highlight pattern for a virtual key corresponding to the key “Y” is, for example, 50%, and a highlight pattern for a virtual key corresponding to the key “U” is, for example, 80%. In this way, the second interaction element on the virtual keyboard 122 may be displayed in a more prominent manner than the first interaction element.

Further, in some embodiments, if the object 130 performs an operation, such as clicking, tapping, pressing, and so on, on at least one interaction element (for example, one or more keys on the keyboard, the left key or the right key of the mouse, one or more keys on the manipulator, and so on), an indication associated with the operation may be displayed on the virtual interaction device 122.

In some embodiments, a display direction of the indication in the virtual scene may be determined by the display direction associated with the virtual interactive device 122. For example, the display direction of the indication may be parallel to the display direction of the virtual interaction device 122. Alternatively, in order to observe the indication more conveniently, the display direction of the indication may be at a predetermined angle to the display direction of the virtual interaction device. For example, the graphical representation of the virtual interaction element corresponding to the at least one interaction element may be highlighted in the predefined angle within the plane defined by the virtual interaction device.

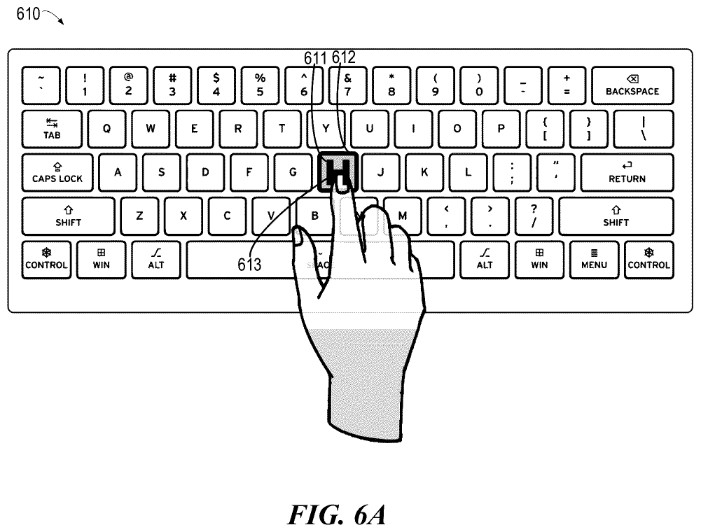

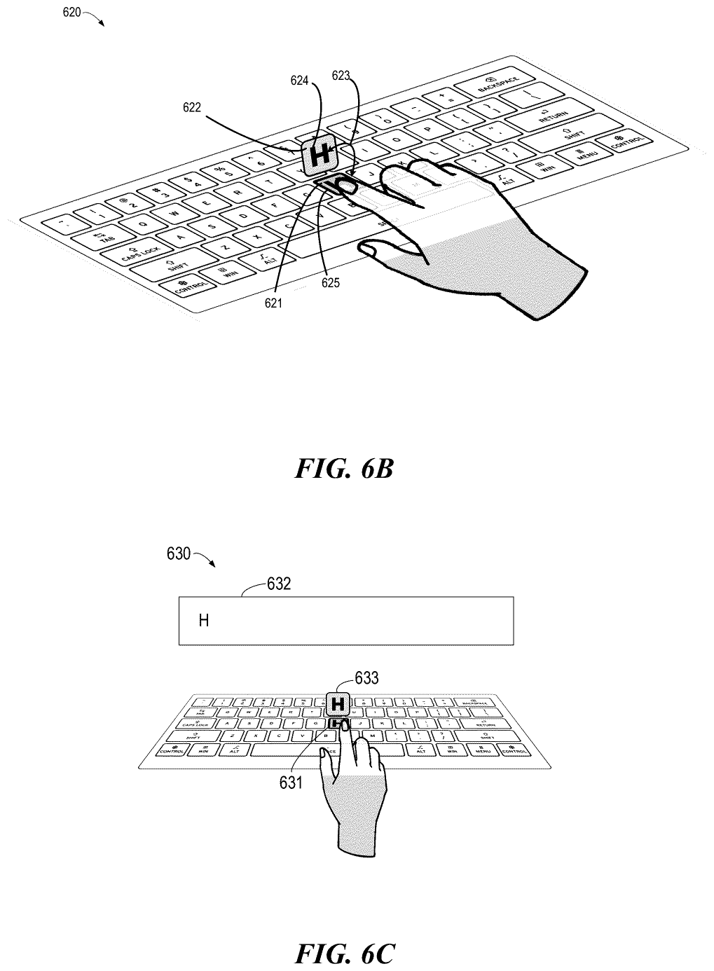

FIG. 6A shows a schematic diagram of a virtual scene 610 for a keystroke operation according to some embodiments of the present disclosure. In the embodiment shown in FIG. 6A, it is assumed that the user 130 places a finger on an interaction element of the physical interaction device, such as a key on the keyboard.

At this time, the virtual interaction element corresponding to the interaction element on the virtual interaction device is highlighted, as shown in FIG. 6A, assuming that a specific key on the physical keyboard corresponds to a virtual key 611, when the finger of the user touches the key on the physical keyboard, the virtual key 611 may be highlighted. For example, the color of a graphical representation 612 of the virtual key 611 is deepened, the symbol on the graphical representation (that is, the symbol corresponding to the key) 613 is displayed in a specific font, color, or size, and so on.

When a user performs an input operation, such as clicking a key on the physical interaction device, an indication associated with the operation may be displayed on the virtual interaction device.

The above input operation and other similar actions of the user may be detected by a relevant electronic device auxiliary device, which will not be repeated here. FIG. 6B shows a schematic diagram of a virtual scene 620 for a keystroke operation according to some embodiments of the present disclosure.

As shown in FIG. 6B, when a user operates an interaction element on the physical interaction device (such as a keyboard), such as a key, the virtual interaction element (such as a virtual key 621) corresponding to the interaction element operated by the user may be in an “active” state. At this time, a graphical representation 622 of the virtual interaction element may be caused to protrude from a plane 625 defined by the virtual keyboard at a predetermined angle 623, that is, the display direction of the graphical representation 622 in the virtual scene may be at the predetermined angle with the display direction of the virtual keyboard. In some embodiments, the predetermined angle 623, for example, may be 90 degrees, and the graphical representation 622 of the virtual key 621 may be displayed vertically at this time. The graphical representation 622 may be displayed in a darker color and may further include a symbol 624 corresponding to the virtual key. It should be understood that the predetermined angle 623 may be any appropriate angle, and the above examples are only illustrative and are not intended to limit the embodiments of the present disclosure.

In addition, the “active” state of the virtual key 621 may be eliminated when the finger of the user 130 is raised. For example, the display of the graphical representation 622 of the virtual interaction element may be canceled.

FIG. 6C shows a schematic diagram of a virtual scene 630 with respect to a keystroke operation according to some embodiments of the present disclosure. In the embodiment shown in FIG. 6C, when the user presses a key on the physical keyboard corresponding to a virtual key 631, a graphical representation 633 of the virtual interaction element (such as the virtual key 631) may be caused to protrude from the plane defined by the virtual keyboard at the predetermined angle in the virtual scene 630. The virtual scene 600 also includes a text box 602, in which a content may be entered. If the user 130 long-presses a certain key, such as a physical key corresponding to the virtual key 631, the symbol corresponding to the key may be repeatedly entered, such as “I”.

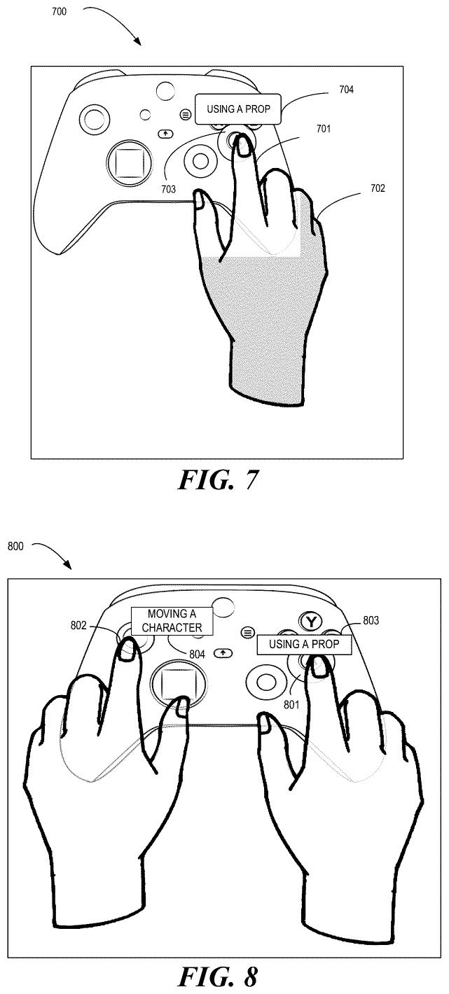

FIG. 7 shows a schematic diagram of a virtual scene 700 regarding a manipulator according to some embodiments of the present disclosure. The manipulator may be a control device such as a game controller or a remote control. In the embodiment shown in FIG. 7, it is assumed that the user 130 places a single finger 111 on the manipulator and focuses on a certain key of the manipulator. Similar to the embodiments of FIG. 3 to FIG. 6, a finger 701 of the virtual avatar (not shown) of the user 130 may be displayed in the gradient translucent material. At the same time, a hand outline 702 of the virtual avatar may be unaffected by the gradient translucency.

As shown in FIG. 7, an area around a virtual key 703 corresponding to the physical key pressed by the finger 701 is highlighted. For example, a graphical display of the virtual key 703 may be realized as a radiation area. The radiation area may have various shapes, such as a circle with the fingertip of the finger 701 as an origin and a radius of N (N>0) centimeters. In addition, the color transparency superimposed by the radiation area may gradually decrease outward from the origin of the circle, for example, from 100% to 0.

In addition, information related to the key may be displayed near the virtual key 703. The information related to the key may include a function manual, an identifier, an abbreviation, a related operation prompt, and so on. As shown in FIG. 7, a function description 704 of the key, such as “using a prop”, is displayed near the virtual key 703. In this way, users can easily understand the corresponding functions of the operated key, thereby improving the operability of users.

FIG. 8 shows a schematic diagram of a virtual scene 800 regarding a manipulator according to other embodiments of the present disclosure. In the embodiment shown in FIG. 8, assuming that the user 130 simultaneously presses two interaction elements (such as keys) on the physical interaction device (such as the manipulator), virtual interaction elements (hereinafter also referred to as “virtual keys”) 801 and 802 corresponding to these two keys on the virtual interaction device (a virtual manipulator) in the virtual scene 800 are highlighted respectively at this time. The highlighting manner is analogous to the embodiment shown in FIG. 7, for example, displaying a graphical display of the virtual interaction element in the radiation area, and gradually decreasing the superimposed transparency of a color outward from the origin of the circle.

In FIG. 8, similar to FIG. 7, information related to these two virtual keys 801 and 802 may also be displayed near these two virtual keys 801 and 802. For example, a function description 803 of the key may be displayed near the virtual key 801, such as “using a prop”. A function description 804 of the key may be displayed near the virtual key 802, such as “moving a character”. In this way, users can easily distinguish the functions corresponding to multiple pressed keys, thereby making a quick operational decision.

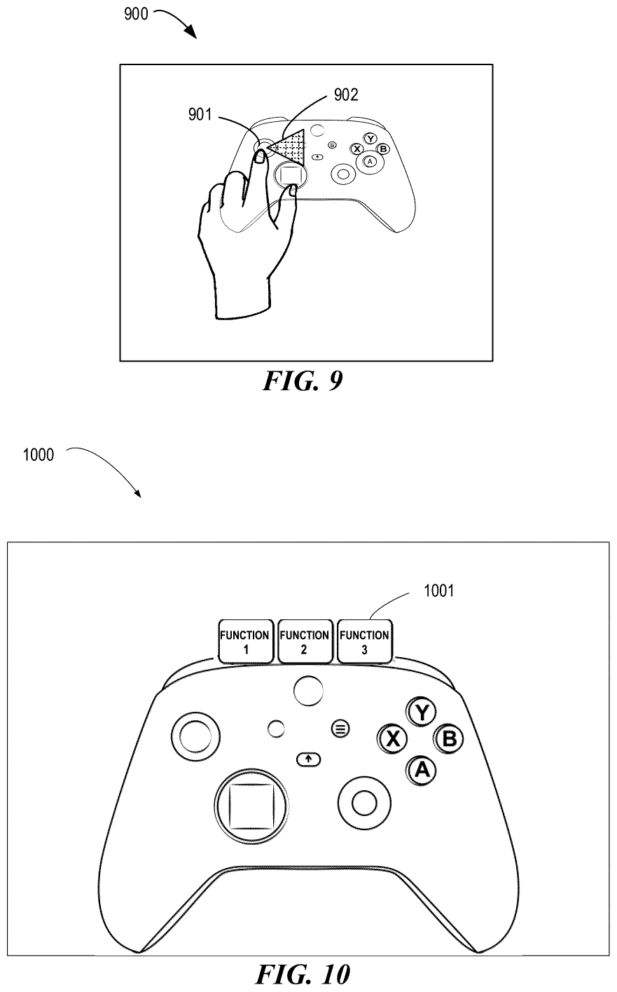

FIG. 9 shows a schematic diagram of a virtual scene 900 with respect to the manipulator according to some other embodiments of the present disclosure. In the embodiment shown in FIG. 9, a user presses a key on the manipulator, which is circular, for example, and an upper part, a lower part, a left part, and a right part of the key may be pressed. These four parts may correspond to different operations. For example, when the upper part of the key is pressed, it represents an upward control action, such as a game player controlling a character in a game to move upward. Similarly, when the lower part, the left part, and the right part of the key are pressed, it represents downward, left, and right control actions, such as the game player controlling the character in the game to move downward, to the left, or to the right.

Assuming that the user presses the right part of the key in the physical scene, some part may be highlighted locally in the virtual scene 900, such as highlighting a sectorial graphical representation 902 to indicate that the right part of a corresponding virtual interaction element (in this embodiment, the virtual key) 901 is pressed. In addition, similar to the embodiments shown in FIG. 7 and FIG. 8, information related to the virtual key 901 may further be displayed near the virtual key 901 in FIG. 9 (not shown). In this way, by locally highlighting and displaying a content differentially, a clear operation prompt may be provided to the user at the virtual key 901.

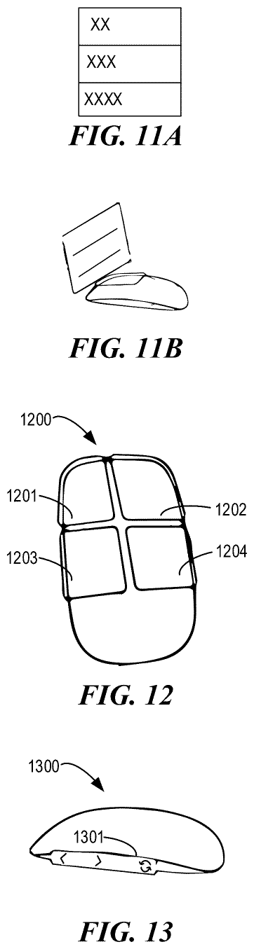

As described above, if the distance between the object and the physical interaction device is less than the predetermined distance, the electronic device 150 may determine the physical area of the physical interaction device to which the object is directed. In some embodiments, the physical area may be a functional part of the physical interaction device, such as a key on a keyboard, a left key or a right key on a mouse, a key on a manipulator, and so on. The virtual area related to the physical area, such as a virtual menu, a shortcut, a virtual key, etc., may be displayed on or near the virtual interaction device. This will be discussed in detail below through FIG. 10, FIG. 11A, and FIG. 11B.

FIG. 10 shows a schematic diagram of a virtual scene 1000 about a manipulator according to some embodiments of the present disclosure. In the embodiment shown in FIG. 10, one or more virtual keys 1001 may be displayed on or near the virtual manipulator, so that users can easily select one or more shortcut functions corresponding to the one or more virtual keys 1001. In this way, the user may directly click on the virtual key 1001 to select the corresponding function, such as quickly switching props. As an alternative, prompt information such as a toolbar or a virtual menu may also be displayed on or near the virtual manipulator for users to select or operate.

FIG. 11A shows a schematic diagram of a menu with respect to a physical interaction device according to some embodiments of the present disclosure. Assuming that the physical interaction device is a mouse, when a user clicks the right key on the mouse in the physical scenario, the physical display of the user will display the menu shown in FIG. 11A. FIG. 11B shows a schematic diagram of a virtual menu related to the virtual interaction device according to some embodiments of the present disclosure. When a user clicks the right key on the mouse in the physical scenario, a virtual menu (such as a secondary panel) similar to the menu shown in FIG. 11A may be displayed near the virtual mouse, such as above the virtual mouse, in the virtual scenario shown in FIG. 11B, facilitating users to make a selection.

Continuing the discussion of the block 230 in the method 200 of FIG. 2, in some embodiments, the electronic device 150 may also utilize the virtual area to provide a physical area independent of the physical interaction device or an additional functional entry independent of the physical interaction device. For example, such an additional function entry cannot be provided by the corresponding physical area, or even by the physical interaction device. This will be discussed in detail below through FIG. 12 to FIG. 14.

The non-functional part of the physical interaction device refers to the part of the physical interaction device that does not provide the corresponding function, such as the part on the keyboard without keys, the part on the mouse, apart from the left and right keys, that cannot be clicked or operated, the part on the manipulator that cannot be operated, and so on. Assuming that the non-functional part is located in a first position on the physical interaction device, there is a corresponding virtual area at the first position on the virtual interaction device. The difference is that the virtual area is a functional part of the virtual interaction device (also referred to as a “virtual functional part” hereinafter), that is, the virtual area may provide users with the corresponding function.

FIG. 12 shows a schematic diagram of a virtual interaction device 1200 according to some embodiments of the present disclosure. In the embodiment of FIG. 12, taking the physical interaction device as a mouse (also known as a “physical mouse”) as an example, the physical interaction device corresponds to the virtual interaction device (in this example, is a “virtual mouse”) 1200. There may be a copy key 1203 and a paste key 1204 below a left key 1201 and a right key 1202 of the virtual mouse 1200, facilitating users to perform a copy/paste operation. There are no copy key or paste key on the physical mouse, and the positions corresponding to these two keys on the physical mouse do not have any function, that is, both of them belong to the non-functional part of the physical mouse. On the virtual mouse, although the copy key 1203 and the paste key 1204 correspond to the non-functional part of the physical mouse in position, they have their respective functions (that is, copy and paste), facilitating users to perform more scalable operations.

FIG. 13 shows a schematic diagram of a virtual interaction device 1300 according to other embodiments of the present disclosure, in which the mouse is still used as an example to describe the physical interaction device corresponding to the virtual interaction device 1200. The side of the physical mouse is the non-functional part, while a toolbar 1301 is provided on the side of the virtual mouse in the embodiment of FIG. 13. The toolbar 1301 is, for example, a navigation toolbar that may provide functions such as forward, backward, and refresh in a browser application, facilitating users to make a selection.

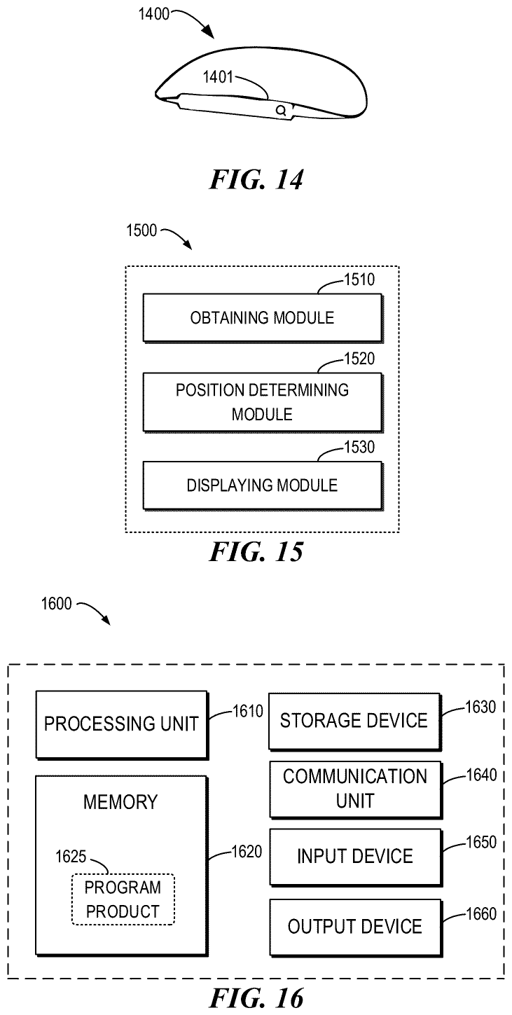

FIG. 14 shows a schematic diagram of a virtual interaction device 1400 according to some embodiments of the present disclosure. Taking the mouse as an example of the physical interaction device, the side of the mouse is a non-functional part, and the user cannot perform any function by operating it. According to the embodiment shown in FIG. 14, a toolbar 1401 is provided on the side of the virtual interaction device (in this embodiment, a virtual mouse) corresponding to the physical interaction device. The toolbar 1401 may provide a search function in a navigation homepage and a function to return to the previous page.

It should be understood that the copy key 1203, the paste key 1204, the toolbar 1301, and the toolbar 1401 discussed in the above examples are merely illustrative and do not limit the embodiments of the present disclosure in any way. In some embodiments according to the present disclosure, the virtual mouse may also be provided with other forms of functional portions, which may present text with specific content, various styles of keys, icons, or the like, to prompt or guide the user to perform a further operation.

In this way, according to the embodiments of the present disclosure, users can be enabled to more easily and more accurately operate the virtual interaction device in a virtual environment, effectively enhancing the user experience.

The embodiments of the present disclosure also provide corresponding apparatus for implementing the above methods or processes. FIG. 15 shows a block diagram of an apparatus 1500 for interacting in a virtual environment according to some embodiments of the present disclosure.

As shown in FIG. 15, the apparatus 1500 includes an obtaining module 1510 configured to obtain an image of the physical scene. The physical scene contains a physical interaction device.

The apparatus 1500 further includes a position determining module 1520 configured to determine, based on the obtained image, a relative position of a predetermined object with respect to the physical interaction device.

In addition, the apparatus 1500 also includes a displaying module 1530, which is configured to display, in a virtual scene corresponding to the physical scene, a virtual interaction device corresponding to the physical interaction device and an indication of the relative position.

In some embodiments, the apparatus 1500 may further include a physical area determining module configured to, in response to a distance between the predetermined object and the physical interaction device being less than a predetermined distance, determine a physical area of the physical interaction device associated with the predetermined object. The displaying module 1530 is further configured to display the indication in association with a virtual area corresponding to the physical area on the virtual interaction device.

In some embodiments, the displaying module 1530 is further configured to, in response to that a target interaction element on the physical interaction device, to which the predetermined object is directed, can be determined based on the relative position, highlight a virtual interaction element corresponding to the target interaction element on the virtual interaction device.

In some embodiments, the apparatus 1500 may further include a potential interaction element determining module configured to, in response to that a target interaction element on the physical interaction device, to which the predetermined object is directed, fails to be determined based on the relative position, determine at least one potential interaction element on the physical interaction device associated with the predetermined object. The displaying module 1530 is further configured to highlighting an area on the virtual interaction device associated with the one or more potential interaction elements.

In some embodiments, the displaying module 1530 may further be configured to highlight a symbol corresponding to a virtual interaction element, or a symbol corresponding to an area associated with the at least one potential interaction element.

In some embodiments, the apparatus 1500 may further include a pattern determining module configured to, for the at least one potential interaction element, determine a highlight pattern for a virtual interaction element corresponding to the potential interaction element based on a distance between the potential interaction element and the predetermined object. The displaying module 1530 is further configured to highlight a corresponding virtual interaction element to the determined pattern.

In some embodiments, the virtual area is configured to provide an additional functional entry independent of the physical area of the physical interaction device.

In some embodiments, the displaying module 1530 may further be configured to display, in the virtual scene, at least a portion of a virtual object representing the predetermined object with a predetermined transparency.

In some embodiments, the displaying module 1530 may further be configured to, in response to the predetermined object performing an operation on at least one interaction element of the physical interaction device, display, on the virtual interaction device, an indication associated with the operation.

In some embodiments, the displaying module 1530 may further be configured to determine a second display direction based on a first display direction associated with the virtual interaction device; display, based on the second display direction, a graphical representation of a virtual interaction element corresponding to the at least one interaction element to highlight the plane defined by the virtual interaction device.

The modules included in the apparatus 1500 may be implemented in various ways, including software, hardware, firmware, or any combination thereof. In some embodiments, one or more units can be implemented using software and/or firmware, such as machine-executable instructions stored on a storage medium. In addition to or as an alternative to machine-executable instructions, some or all of the modules in the apparatus 1500 can be implemented at least partially by one or more hardware logic components. By way of example and not limitation, exemplary types of hardware logic components that can be used include field programmable gate arrays (FPGAs), application specific integrated circuits (ASICs), application specific standards (ASSPs), system-on-chips (SOCs), complex programmable logic devices (CPLDs), and the like.

FIG. 16 shows a block diagram of a computing device/server 1600 in which one or more embodiments of the present disclosure may be implemented. The electronic device 150 of FIG. 1 may be implemented, for example, by the computing device/server 1600 shown in FIG. 16. It should be understood that the computing device/server 1600 shown in FIG. 16 is merely an example and should not constitute any limitation on the functionality and scope of the embodiments described herein.

As shown in FIG. 16, the computing device/server 1600 is in a form of a general purpose computing device. components of the computing device/server 1600 may include, but are not limited to, one or more processors or a processing unit 1610, a memory 1620, a storage device 1630, one or more communication units 1640, one or more input devices 1660, and one or more output devices 1660. The processing unit 1610 may be an actual or virtual processor and is capable of performing various processing according to the program stored in the memory 1620. In a multiprocessor system, multiple processing units execute computer-executable instructions in parallel to enhance the parallel processing capability of the computing device/server 1600.

The computing device/server 1600 typically includes multiple computer storage mediums. Such mediums may be any available medium accessible to the computing device/server 1600, including but not limited to a volatile medium and a non-volatile medium, a removable medium and a non-removable medium. The memory 1620 may be a volatile memory (such as a register, a cache, a random access memory (RAM)), a non-volatile memory (such as a read-only memory (ROM), an electrically erasable programmable read-only memory (EEPROM), a flash memory), or any combination thereof. The storage device 1630 may be a removable medium or a non-removable medium, and may include a machine-readable medium such as a flash drive, a disk, or any other medium that may be used to store information and/or data (such as training data for training) and may be accessed within the computing device/server 1600.

The computing device/server 1600 may further include an additional removable/non-removable, volatile/nonvolatile storage medium. although not shown in FIG. 16, a disk drive for reading from or writing into a removable, nonvolatile disk (e.g., “floppy disk”) and an optical disk drive for reading from or writing into a removable, nonvolatile optical disk may be provided. In these cases, each drive may be connected to a bus (not shown) by one or more data medium interfaces. The memory 1620 may include a computer program product 1625, which has one or more program modules configured to perform various methods or actions of various embodiments disclosed in this disclosure.

The communication unit 1640 implements communication with other computing devices through a communication medium. Additionally, the functions of the components of the computing device/server 1600 can be implemented as a single computing cluster or multiple computing machines, which can communicate through communication connections. Therefore, the computing device/server 1600 may operate in a networked environment using logical connections with one or more other servers, network personal computers (PCs), or another network node.

An input device 1650 may be one or more input devices, such as a mouse, a keyboard, a trackball, etc. The output device 1660 may be one or more output devices, such as a display, a speaker, a printer, etc. The computing device/server 1600 may further communicate with one or more external devices (not shown) through the communication unit 1640 as needed, such as a storage device, a displaying device, etc., which communicates with one or more devices that enable users to interact with the computing device/server 1600, or communicates with any device (such as a network card, a modem, etc.) that enables the computing device/server 1600 to communicate with one or more other computing devices. Such communication may be performed via an input/output (I/O) interface (not shown).

According to example implementations of the present disclosure, there is provided a computer-readable storage medium having stored thereon one or more computer instructions, where the one or more computer instructions are executed by a processor to implement the methods described above.

Various aspects of the present disclosure are described herein with reference to flowcharts and/or block diagrams of methods, apparatus (systems), and computer program products implemented in accordance with the present disclosure. It should be understood that each block of the flowcharts and/or block diagrams and combinations of blocks in the flowcharts and/or block diagrams can be implemented by computer-readable program instructions.

These computer-readable program instructions can be provided to a processing unit of a general-purpose computer, a dedicated computer, or other programmable data processing devices to produce a machine that, when executed by a processing unit of a computer or other programmable data processing devices, produces a device that implements the functions/actions specified in one or more blocks in the flowchart and/or block diagram. These computer-readable program instructions can also be stored in a computer-readable storage medium, which causes a computer, a programmable data processing device, and/or other devices to operate in a specific manner. Therefore, the computer-readable medium storing the instructions includes an article of manufacture that includes instructions for implementing various aspects of the functions/actions specified in one or more blocks in the flowchart and/or block diagram.

The computer-readable program instructions can also be loaded onto a computer, other programmable data processing devices, or other devices to perform a series of operational steps on the computer, other programmable data processing devices, or other devices to produce a computer-implemented process, so that the instructions executed on the computer, other programmable data processing device, or other devices implement the functions/actions specified in one or more blocks in the flowchart and/or block diagram.

The flowcharts and block diagrams in the drawings show a possible architecture, functions, and operations of the systems, methods, and computer program products implemented according to the present disclosure. In this regard, each block in the flowcharts or block diagrams can represent a module, a program segment, or a part of an instruction, which contains one or more executable instructions for implementing the specified logical functions. In some alternative implementations, the functions labeled in the blocks may also occur in a different order than those labeled in the figures. For example, two consecutive blocks may actually be executed in substantially parallel, and they may sometimes be executed in the opposite order, depending on the functions involved. It should also be noted that each block in the diagrams and/or flowcharts, as well as combinations of blocks in the diagrams and/or flowcharts, may be implemented using dedicated hardware-based systems that perform the specified functions or actions, or may be implemented using a combination of dedicated hardware and computer instructions.

The above has described various implementations of the present disclosure. The above description is exemplary, not exhaustive, and is not limited to the various implementations disclosed. Without departing from the scope and spirit of the various implementations described, many modifications and changes are obvious to ordinary technicians in this field. The choice of terms used in this disclosure is intended to best explain the principles, practical applications, or improvements to the technology in the field, or to enable other ordinary technicians in this field to understand the various implementations disclosed in this disclosure.

I/we claim:

1. A method for interacting in a virtual environment, comprising:
obtaining an image of a physical scene, the physical scene containing a physical interaction device;
determining, based on the obtained image, a relative position of a predetermined object with respect to the physical interaction device; and
displaying, in a virtual scene corresponding to the physical scene, a virtual interaction device corresponding to the physical interaction device and an indication of the relative position.

2. The method of claim 1, wherein displaying the indication comprises:
in response to a distance between the predetermined object and the physical interaction device being less than a predetermined distance, determining a physical area of the physical interaction device associated with the predetermined object; and
displaying the indication in association with a virtual area corresponding to the physical area on the virtual interaction device.

3. The method of claim 2, further comprising:
in response to that a target interaction element on the physical interaction device, to which the predetermined object is directed, can be determined based on the relative position, highlighting a virtual interaction element corresponding to the target interaction element on the virtual interaction device.

4. The method of claim 2, further comprising:
in response to that a target interaction element on the physical interaction device, to which the predetermined object is directed, fails to be determined based on the relative position,
determining at least one potential interaction element on the physical interaction device associated with the predetermined object, and
highlighting an area on the virtual interaction device associated with the one or more potential interaction elements.

5. The method of claim 3, further comprising:
highlighting a symbol corresponding to a virtual interaction element, or a symbol corresponding to an area associated with the at least one potential interaction element.

6. The method of claim 4, wherein highlighting the area comprises:
for the at least one potential interaction element, determining a highlight pattern for a virtual interaction element corresponding to the potential interaction element based on a distance between the potential interaction element and the predetermined object; and
highlighting a corresponding virtual interaction element to the determined pattern.

7. The method of claim 2, wherein the virtual area is configured to provide an additional functional entry independent of the physical area of the physical interaction device.

8. The method of claim 1, further comprising:
displaying, in the virtual scene, at least a portion of a virtual object representing the predetermined object with a predetermined transparency.

9. The method of claim 1, further comprising:
in response to the predetermined object performing an operation on at least one interaction element of the physical interaction device, displaying, on the virtual interaction device, an indication associated with the operation.

10. The method of claim 9, wherein displaying the indication associated with the operation comprises:
determining a second display direction based on a first display direction associated with the virtual interaction device; and
displaying, based on the second display direction, a graphical representation of a virtual interaction element corresponding to the at least one interaction element.

11. The method of claim 1, wherein the physical interaction device comprises a physical I/O device associated with the virtual scene.

12. An electronic device, comprising:
at least one processing unit; and
at least one memory, the at least one memory being coupled to the at least one processing unit and storing an instruction for execution by the at least one processing unit, the instruction, when executed by the at least one processing unit, causing the device to perform acts comprising:
obtaining an image of a physical scene, the physical scene containing a physical interaction device;
determining, based on the obtained image, a relative position of a predetermined object with respect to the physical interaction device; and
displaying, in a virtual scene corresponding to the physical scene, a virtual interaction device corresponding to the physical interaction device and an indication of the relative position.

13. The electronic device of claim 12, wherein displaying the indication comprises:
in response to a distance between the predetermined object and the physical interaction device being less than a predetermined distance, determining a physical area of the physical interaction device associated with the predetermined object; and
displaying the indication in association with a virtual area corresponding to the physical area on the virtual interaction device.

14. The electronic device of claim 13, the acts further comprising:
in response to that a target interaction element on the physical interaction device, to which the predetermined object is directed, can be determined based on the relative position, highlighting a virtual interaction element corresponding to the target interaction element on the virtual interaction device.

15. The electronic device of claim 13, the acts further comprising:
in response to that a target interaction element on the physical interaction device, to which the predetermined object is directed, fails to be determined based on the relative position,
determining at least one potential interaction element on the physical interaction device associated with the predetermined object, and
highlighting an area on the virtual interaction device associated with the one or more potential interaction elements.

16. The electronic device of claim 14, the acts further comprising:
highlighting a symbol corresponding to a virtual interaction element, or a symbol corresponding to an area associated with the at least one potential interaction element.

17. The electronic device of claim 15, wherein highlighting the area comprises:
for the at least one potential interaction element, determining a highlight pattern for a virtual interaction element corresponding to the potential interaction element based on a distance between the potential interaction element and the predetermined object; and
highlighting a corresponding virtual interaction element to the determined pattern.

18. The electronic device of claim 13, wherein the virtual area is configured to provide an additional functional entry independent of the physical area of the physical interaction device.

19. The electronic device of claim 12, the acts further comprising:
displaying, in the virtual scene, at least a portion of a virtual object representing the predetermined object with a predetermined transparency.

20. A computer readable storage medium, having stored thereon a computer program which, when executed by a processor, implements acts comprising:
obtaining an image of a physical scene, the physical scene containing a physical interaction device;
determining, based on the obtained image, a relative position of a predetermined object with respect to the physical interaction device; and
displaying, in a virtual scene corresponding to the physical scene, a virtual interaction device corresponding to the physical interaction device and an indication of the relative position.
